(19) United States
(12) Patent Application Publication
(10) Pub. No.: US 2012/0307052 A1
(43) Pub. Date: Dec. 6, 2012

(54) SYSTEM AND METHOD FOR THUMBNAIL-BASED CAMERA CONTROL

(75) Inventors: Hari Thiruvengada, Plymouth, MN (US); Paul Derby, Lubbock, TX (US); Tom Plocher, Hugo, MN (US); Henry Chen, Beijing (CN)

(73) Assignee: Honeywell International Inc., Morristown, NJ (US)

(21) Appl. No.: 13/152,968

(22) Filed: Jun. 3, 2011

(51) Int. Cl. H04N 7/18

(52) U.S. Cl. 348/143; 348/E07.085

(57) ABSTRACT

A system includes a video sensing device, a computer processor coupled to the video sensing device, and a display unit coupled to the computer processor. The system is configured to display a field of view of the video sensing device as a thumbnail on a main display of an area, receive input from a user, wherein the input received from the user is received via one or more of a pan icon, a zoom icon, and a tilt icon, automatically calculate a change in one or more of a pan, a tilt, and a zoom of the video sensing device as a function of the input, alter one or more of the pan, the tilt, and the zoom of the video sensing device as a function of the calculations, and display a new field of view of the video sensing device in the thumbnail as a function of the alteration of the pan, tilt, and zoom of the video sensing device.

### TECHNICAL FIELD

The present disclosure relates to a system and method to control surveillance cameras, and in an embodiment, but not by way of limitation, a system and method for thumbnail-based camera control.

### BACKGROUND

Controlling video cameras is problematic for security/surveillance personnel. Current camera control interfaces require operators to change camera pan, tilt, or zoom by changing the value of each separately, often by literally changing the numeric value for the selected camera parameter. These values translate poorly, if at all, to what the operator actually sees on the system's video display unit. What security operators care most about are things moving on the ground (intruders), and the location of intruders on the ground.

### BRIEF DESCRIPTION OF THE DRAWINGS

FIG. 1 illustrates an embodiment of a thumbnail image, a video icon, and a footprint icon.

FIG. 2 illustrates an embodiment of a pan functionality of a thumbnail image, a video icon, and a footprint icon.

FIG. 3 illustrates another embodiment of a pan functionality of a thumbnail image, a video icon, and a footprint icon.

FIG. 4 illustrates an embodiment of a tilt functionality of a thumbnail image, a video icon, and a footprint icon.

FIG. 5 illustrates an embodiment of a zoom functionality of a thumbnail image, a video icon, and a footprint icon.

FIG. 6 illustrates an embodiment of a thumbnail image, a video icon, and a footprint icon that displays parameters of a camera in the thumbnail image.

FIG. 6A illustrates another embodiment of a thumbnail image, a video icon, and a footprint icon that displays parameters of a camera in the thumbnail image.

FIG. 7 illustrates an embodiment of a thumbnail image that displays locations of interest or hot spots in the thumbnail image.

FIG. 8 illustrates an embodiment of a thumbnail image, a video icon, and a footprint icon positioned on a main display of a video surveillance system.

FIGS. 9A, 9B, and 9C are a flow chart of an example process to display a thumbnail image, a video icon, and a footprint icon on a main display unit.

FIG. 10 is a block diagram of a computer processor system upon which one or more embodiments of the present disclosure can execute.

### DETAILED DESCRIPTION

An embodiment can be referred to as thumbnail-based camera control. This embodiment allows an operator to control the pan, tilt, and zoom parameters of a camera within the context of a video image thumbnail. The pan, tilt, and zoom controls are anchored within the thumbnail, thereby creating easy control and providing immediate visual feedback to the operator. In an embodiment, the zoom controls are anchored on the edge of the thumbnail. The image is also tied into a camera icon using a typical callout that identifies the camera related to the current video feed. That is, in the thumbnail-based embodiment, the current image and camera icon are tied together. Consequently, when the operator pans, tilts or zooms using the anchored controls, the icon changes appropriately, thereby providing reinforcing feedback to the user. The limits for the camera controls are also shown on the video feed and the anchor. For example, when the operator reaches the pan limit, the anchored control for pan changes a characteristic (such as color) and the icon on the image also changes a characteristic (such as a different shape and color). The thumbnail can also be moved and resized without losing context about the originating camera.

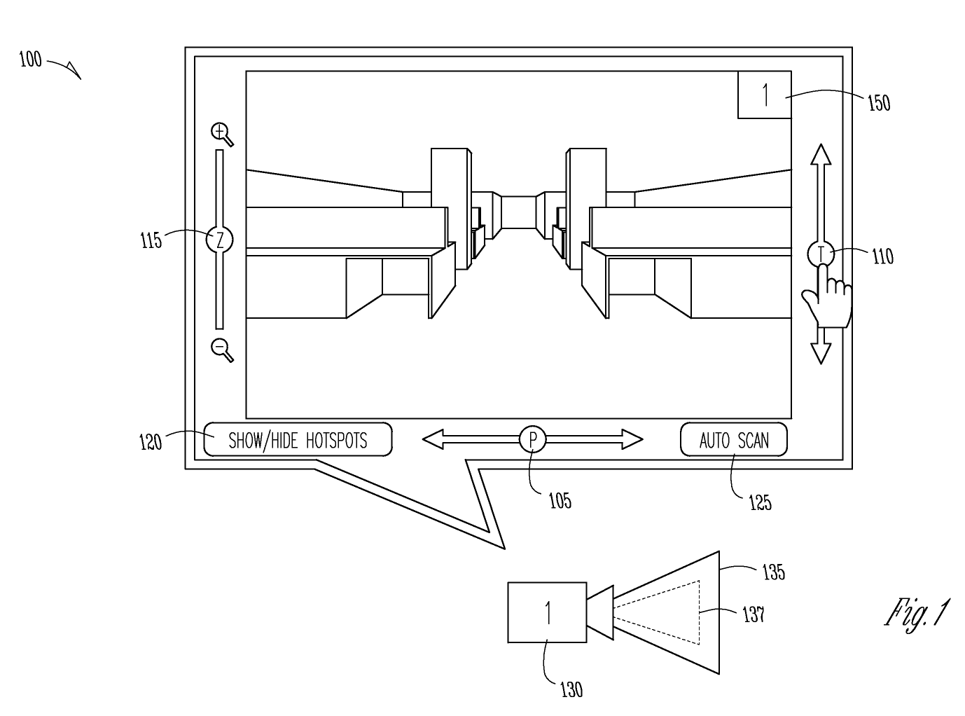

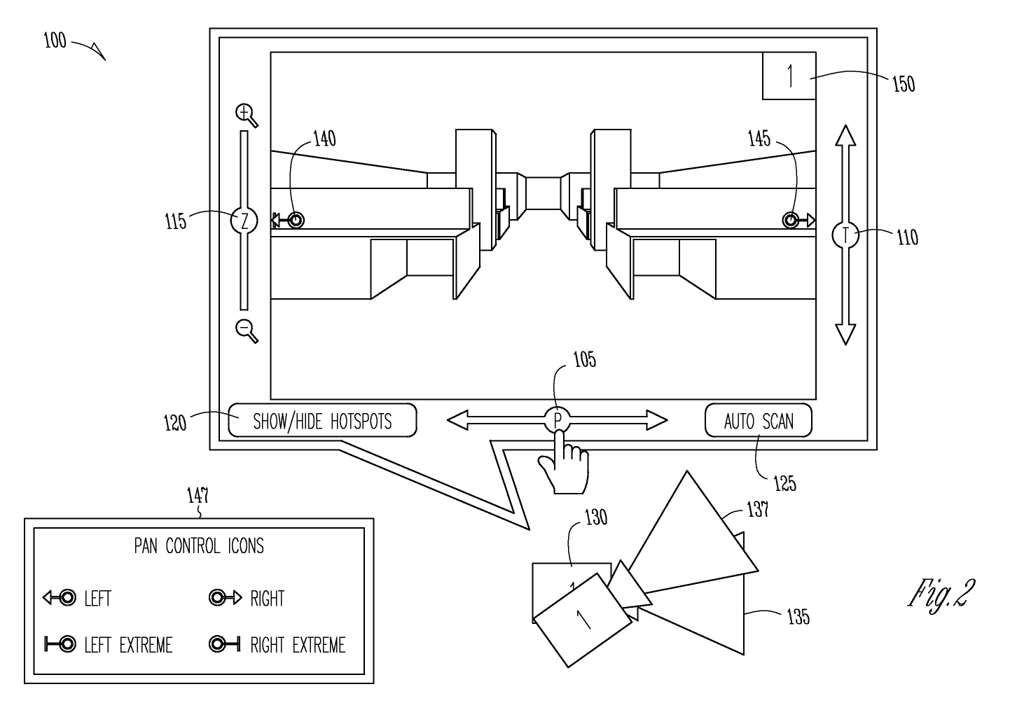

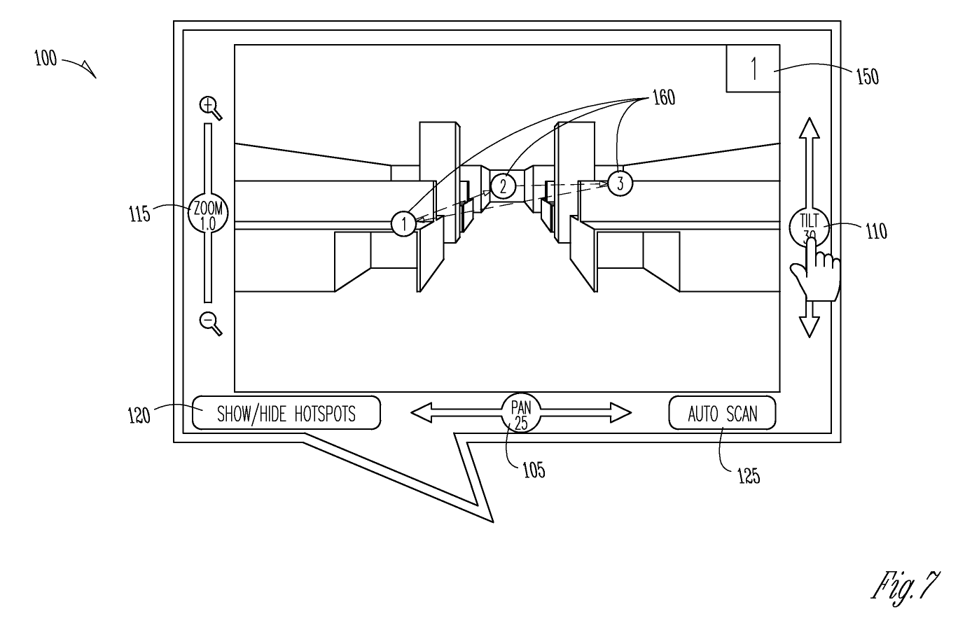

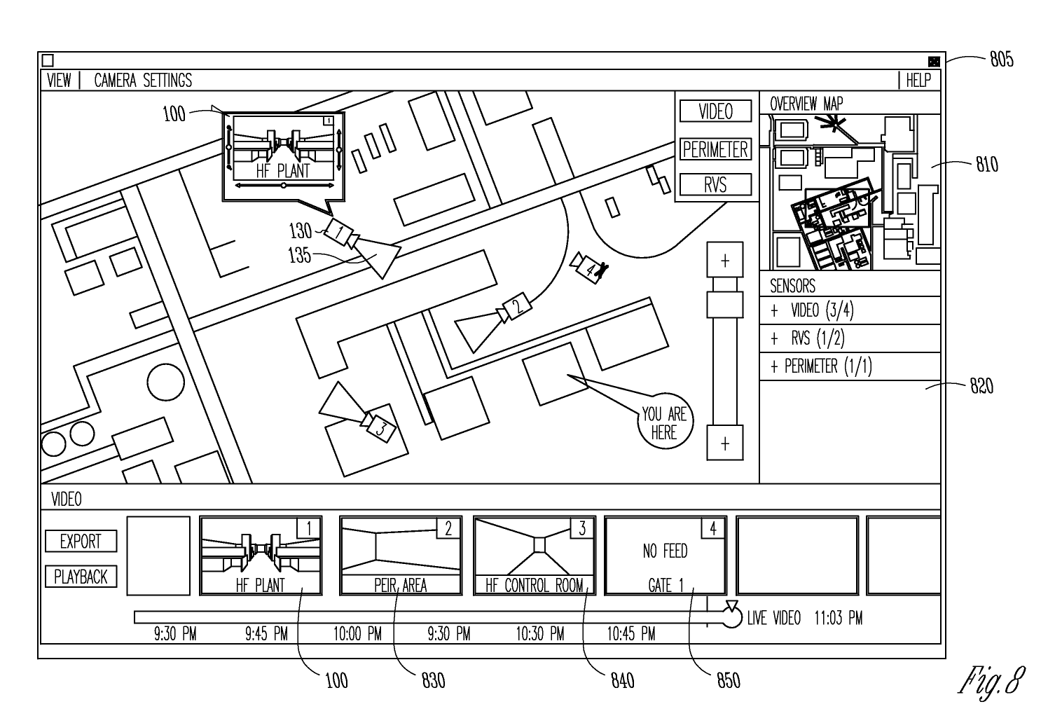

FIG. 1 illustrates an embodiment of a thumbnail image, a video icon, and a footprint icon, and FIG. 8 illustrates an embodiment of a thumbnail image, a video icon, and a footprint icon positioned on a main display of a video surveillance system. FIG. 8 will be discussed in detail later on herein. Referring now specifically to FIG. 1, a thumbnail 100 includes a pan icon 105, a tilt icon 110, and a zoom icon 115. The icons 105, 110, and 115 can include any means to receive input from a user such as a slide bar, an arrow, an increase button, a decrease button, or any other type of widget. The thumbnail 100 also includes a SHOW/HIDE Hotspots button 120, and an autoscan button 125. A hotspot is a particular area within the thumbnail, such as a door, a window, or an expensive piece of equipment, that is of particular interest to a user. A hotspot can also be referred to as a location of interest. Hotspots and their use will be discussed in further detail in connection with FIG. 7. The thumbnail further includes or is associated with a camera icon 130, and an icon of the footprint 135 of the camera. The footprint 135 of a camera represents the ground or area that is covered by the camera. FIG. 1 further illustrates the change that occurs in the footprint of the camera as a result of changing the pan, tilt, and/or zoom of the camera via the pan icon 105, the tilt icon 110, and/or the zoom icon 115. Specifically, the changes made via the pan, tilt, and zoom icons result in a synchronous change in the footprint icon 135 to a new icon 137.

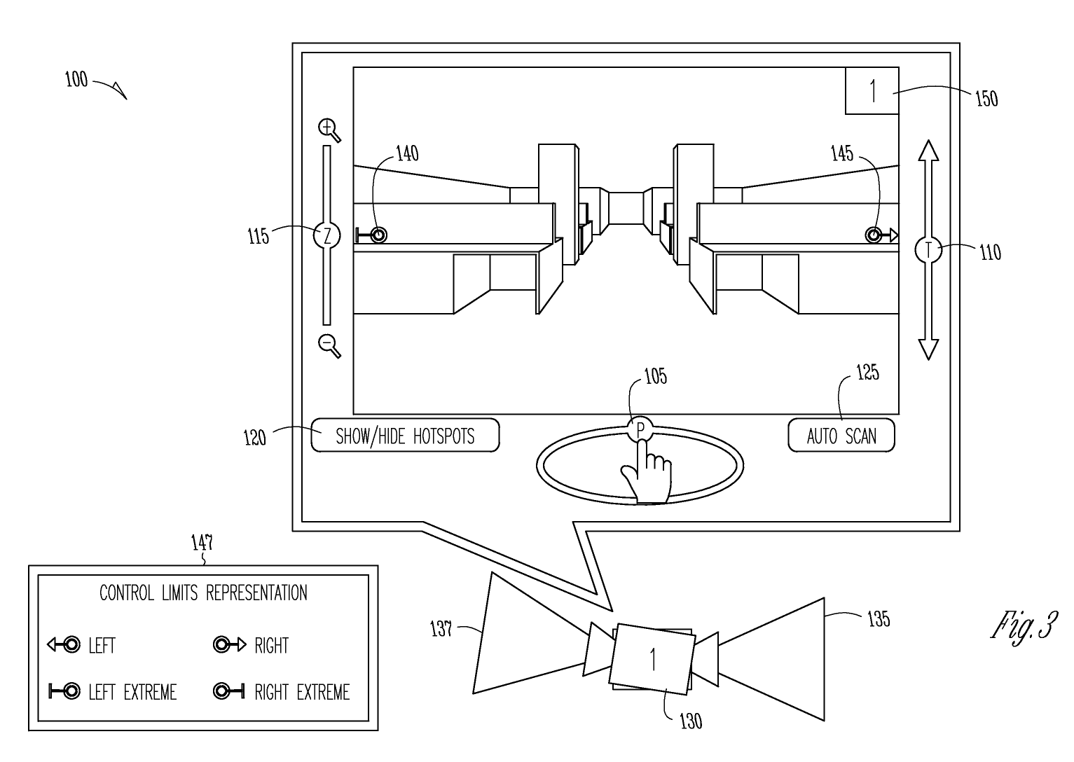

FIG. 2 illustrates an embodiment of a pan functionality of the thumbnail image 100, the camera icon 130, and the footprint icon 135. FIG. 2 further illustrates pan control icons 147, which the user can use to pan to the left or right, and to pan to the extreme left or extreme right limits of the camera. Examples of these pan control icons 147 are illustrated in the thumbnail 100 at 140 and 145. In the embodiment of FIG. 2, when the user slides the circular ball on the pan bar 105, the actual camera image and the camera icon synchronously pan on the display unit. That is, the image in the thumbnail will change per the panning of the actual camera, and the icon 130 will synchronously pan, and the footprint icon 135 will pan to footprint 137. Further in the embodiment of FIG. 2, when the pan limit is reached, the circular ball with the P character can change character, such as by changing color, indicating that the limits of the camera have been reached and further panning in that direction is not possible.

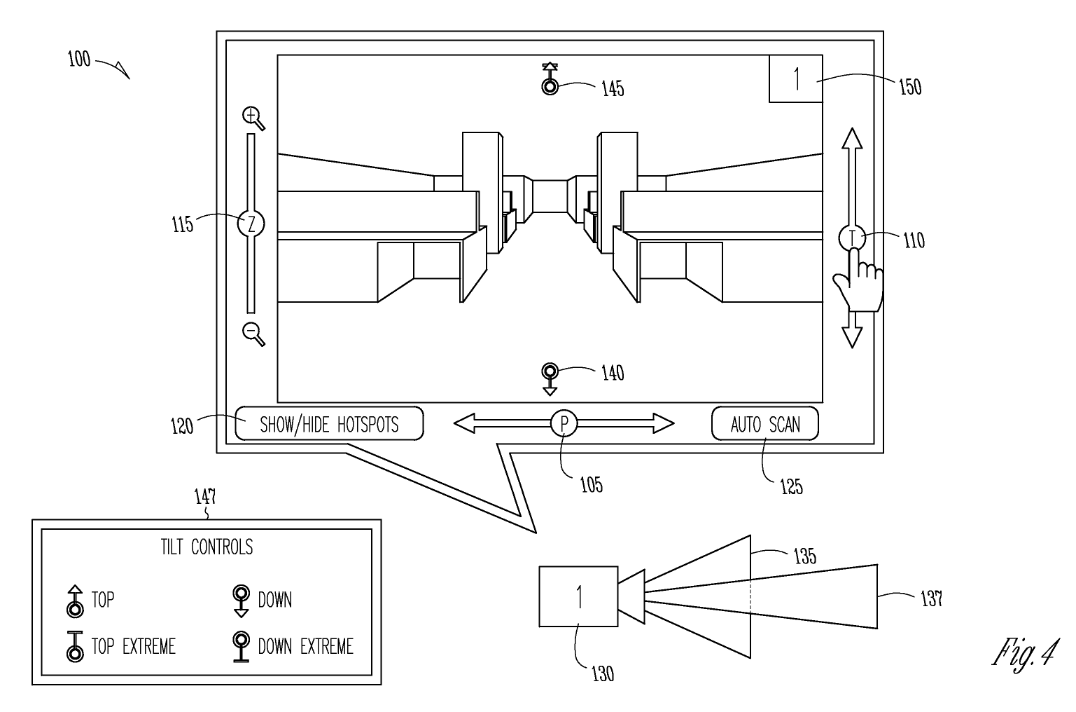

FIG. 3 illustrates another embodiment of a pan functionality of a thumbnail image, a video icon, and a footprint icon. Specifically, FIG. 3 illustrates an embodiment wherein the actual camera has a 360 degree pan capability. This is illustrated by the oval pan icon 105, the camera icon 130, and the footprint icons 135, 137 in FIG. 3.

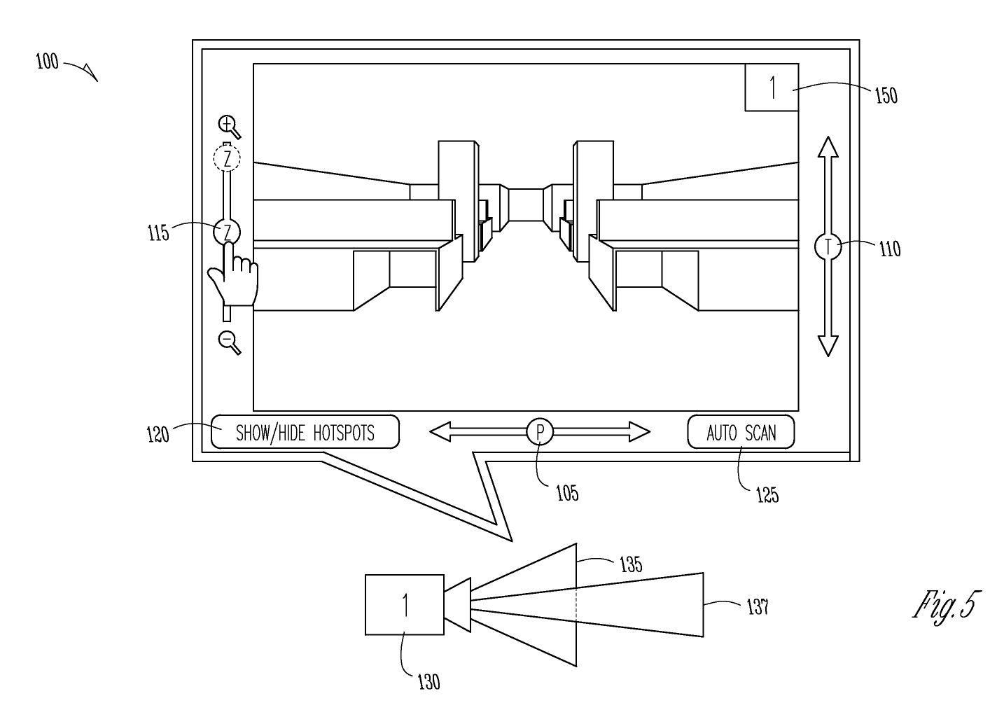

FIG. 4 illustrates an embodiment of a tilt functionality of the thumbnail image 100, the camera icon 130, and the footprint icon 135. The tilt bar 110 will cause the actual camera to tilt up or down, the tilt icon 145 will cause the actual camera to tilt up, and the tilt icon 140 will cause the actual camera to tilt down. For example, when a user slides the circular ball on the tilt bar 110, the actual camera image and the camera icon synchronously tilt on the display unit (and the footprint changes synchronously). If the tilt limit of the actual camera is reached, a character of the tilt bar 110 or circular ball (such as color) is changed to indicate that the tilt limit of the camera has been reached. If the tilt icons 140, 145 have the extreme feature, the selection of those icons will cause the camera to go to either its up-most tilt or its lower-most tilt. The camera icon 130 illustrates a first footprint 135, and also a second footprint 137 that results from the camera 130 tilting down (footprint becomes more narrow).

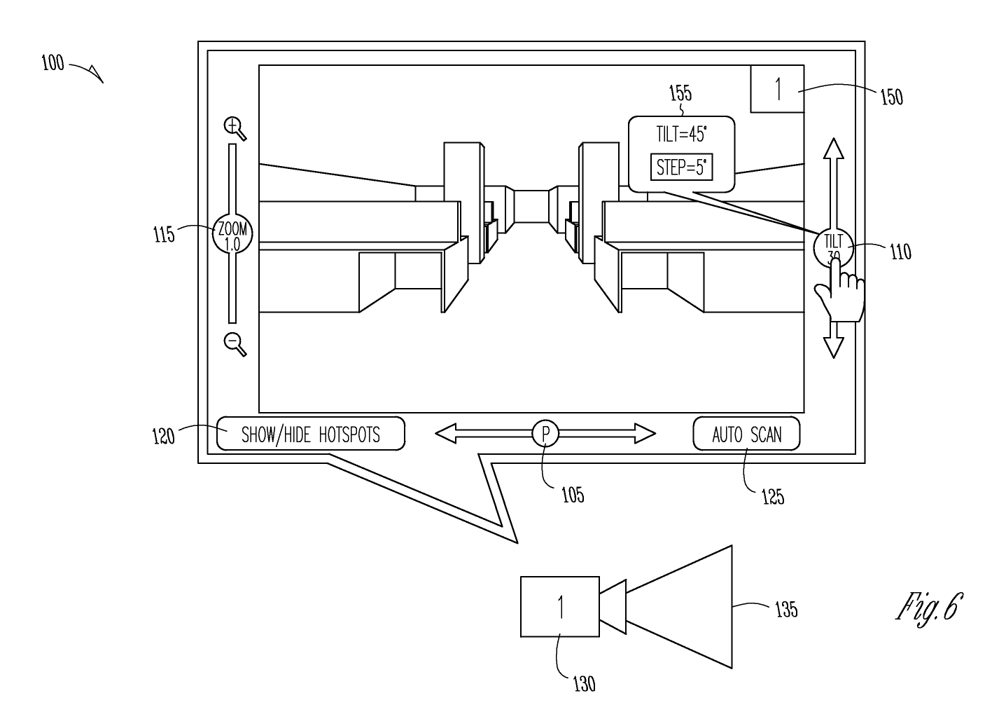

FIG. 5 illustrates an embodiment of a zoom functionality of the thumbnail image 100, a camera icon 130, and the footprint icons 135, 137. When a user slides the circular ball of the zoom bar 115, the actual camera image 100 and the camera icon 130 zooms on the display unit in synchronous fashion. When the zoom limit of the camera is reached, a characteristic of the zoom bar 115 (such as its color) is changed to indicate that the zoom limit has been reached. As indicated by the footprint icons 135, 137, the actual camera has zoomed out from a footprint of 135 to a footprint of 137.

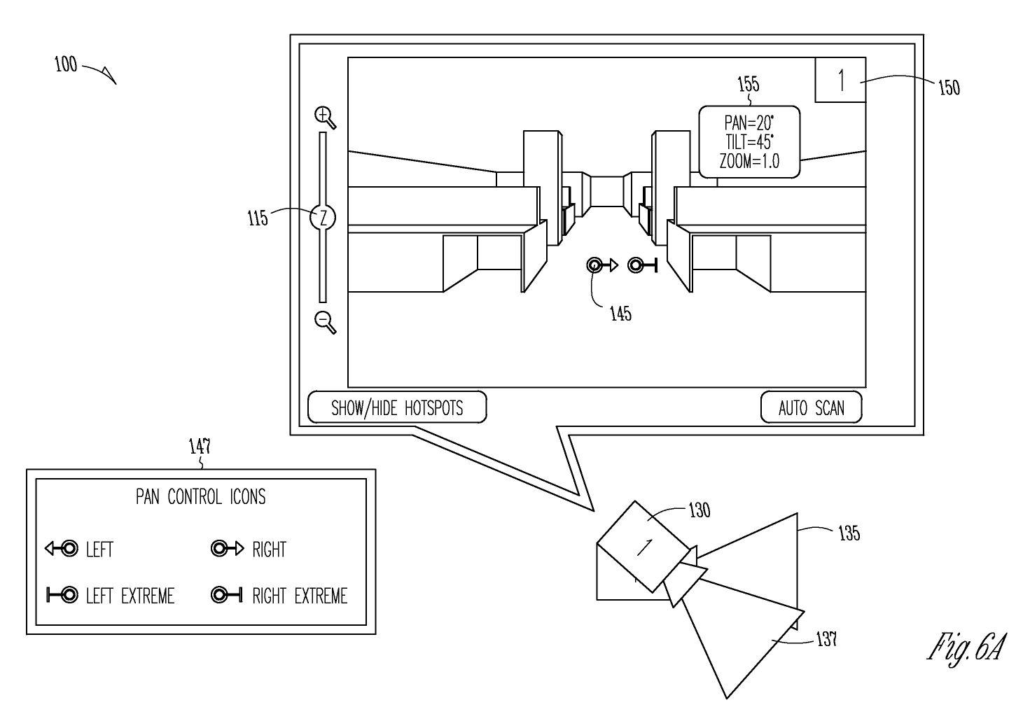

FIGS. 6 and 6A illustrate another embodiment of a thumbnail image 100, a camera icon 130, and a footprint icon 135 that displays parameters of a camera in the thumbnail image. FIG. 6 illustrates at 155 that the current tilt of the camera is at 45 degrees. FIG. 6 further indicates that for each detectable movement of the circular ball on the tilt bar 110, the camera tilt will change by a 5 degree step. In an embodiment, this step can be modified by the user so that each detectable movement of the circular ball results in a step of different magnitude. FIG. 6A illustrates at 155 the values for each of the pan, tilt, and zoom parameters. FIG. 6A further illustrates that the footprint has changed from position 135 to position 137.

FIG. 7 illustrates an embodiment of the thumbnail image 100 that displays locations of interest or hot spots 160 in the thumbnail image. A user can set automatic hot spots 160 within a thumbnail 100 that a camera will point to and scan for anomalies or intrusions. The user can also set the camera to auto pan, tilt, and zoom using a play functionality on the thumbnail. For example, if there are three hot spots as shown at 160 in FIG. 7, the camera can be set to automatically scan these hotspots in the 1-2-3 sequence shown in FIG. 7. This auto scanning function is initiated by the auto scan button 125. The user can also cause the camera to move to a hotspot by clicking on the hotspot in the thumbnail after viewing transparent hotspots within the thumbnail using the Show/Hide Hotspots button 120. The camera can also generate an automated video output of the scanned areas based on preset or periodic scan tasks that are scheduled in the system. The Show/Hide Hotspots button 120 shows in the thumbnail the positions of the hotspots 160, and is also used to disable one or more hotspots (hide).

FIG. 8 illustrates an embodiment of a thumbnail image 100, a camera icon 130, and a footprint icon 135 positioned on a main display 805 of a video surveillance system. The main display 805 illustrates a campus or facility, and the positions, orientations, and footprints of three cameras on the campus. A fourth camera is not operational, as indicated by the X over the camera icon. The camera number 1 has its thumbnail 100 displayed within the main display 805, and also at the bottom of the main display. All of the above-described functions in connection with the thumbnail 100 can be implemented through the thumbnail 100 in the main display 805. The live video feeds for cameras 2 and 3 (830, 840) are displayed on the bottom of the main display 805, and further indicates that camera 4 (850) has no live feed at this point in time. The main display of FIG. 8 further includes an overview map 810 and a listing of the sensors 820.

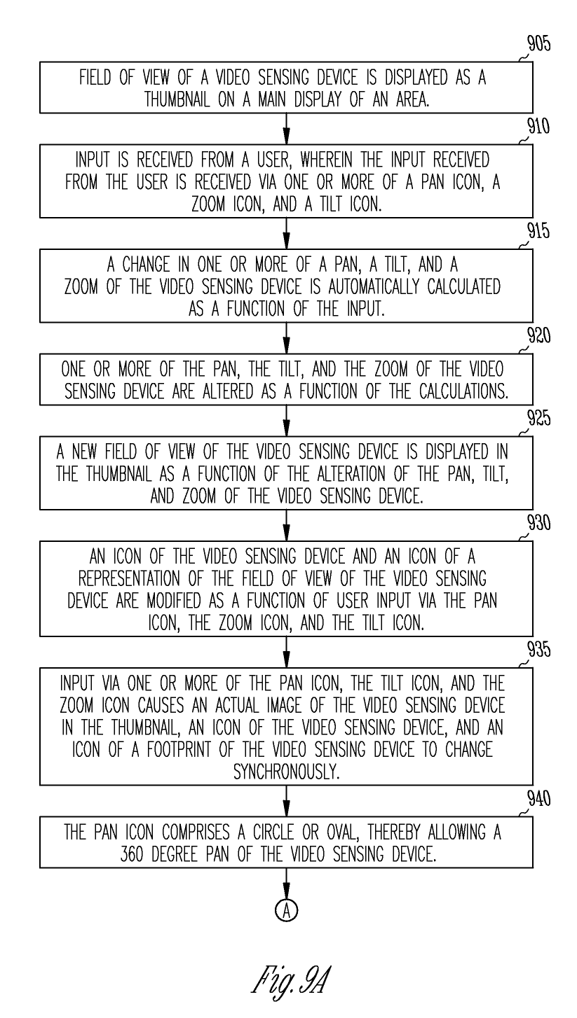

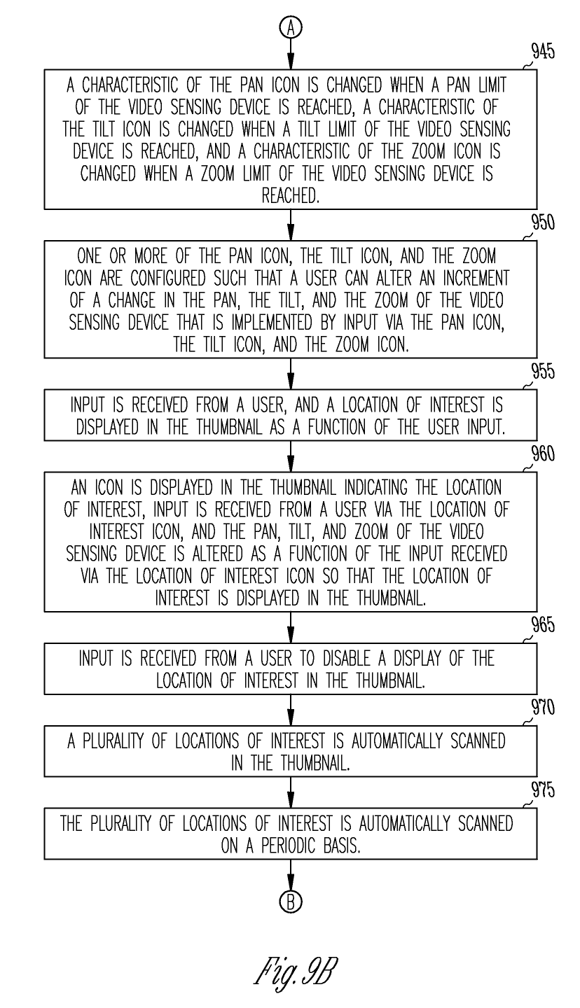

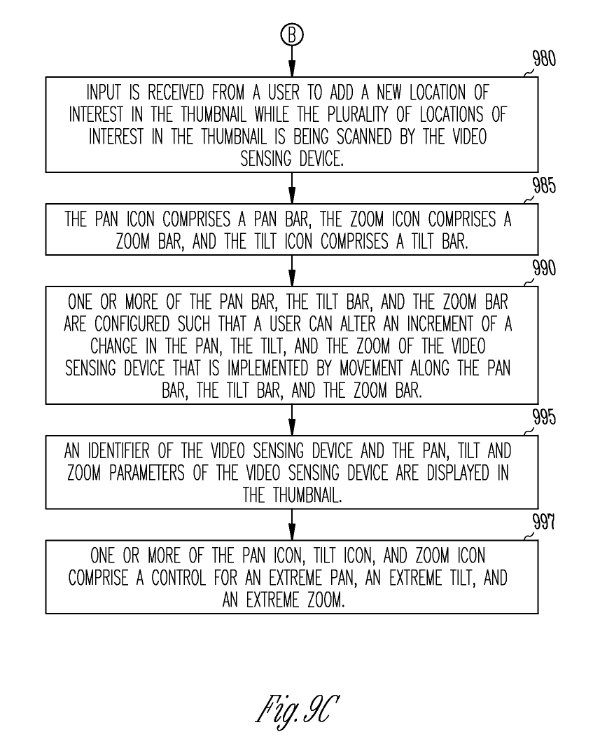

FIGS. 9A, 9B, and 9C are a flow chart of an example process to display a thumbnail image, a video icon, and a footprint icon on a main display unit. FIGS. 9A, 9B and 9C include a number of process blocks 905-997. Though arranged serially in the example of FIGS. 9A, 9B, and 9C, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 9A, 9B, and 9C, at 905, a field of view of a video sensing device is displayed as a thumbnail on a main display of an area. At 910, input is received from a user, wherein the input received from the user is received via one or more of a pan icon, a zoom icon, and a tilt icon. At 915, a change in one or more of a pan, a tilt, and a zoom of the video sensing device is automatically calculated as a function of the input. At 920, one or more of the pan, the tilt, and the zoom of the video sensing device are altered as a function of the calculations. At 925, a new field of view of the video sensing device is displayed in the thumbnail as a function of the alteration of the pan, tilt, and zoom of the video sensing device.

At 930, an icon of the video sensing device and an icon of a representation of the field of view of the video sensing device are modified as a function of user input via the pan icon, the zoom icon, and the tilt icon. At 935, input via one or more of the pan icon, the tilt icon, and the zoom icon causes an actual image of the video sensing device in the thumbnail, an icon of the video sensing device, and an icon of a footprint of the video sensing device to change synchronously. At 940, the pan icon comprises a circle or oval, thereby allowing a 360 degree pan of the video sensing device. At 945, a characteristic of the pan icon is changed when a pan limit of the video sensing device is reached, a characteristic of the tilt icon is changed when a tilt limit of the video sensing device is reached, and a characteristic of the zoom icon is changed when a zoom limit of the video sensing device is reached. At 950, one or more of the pan icon, the tilt icon, and the zoom icon are configured such that a user can alter an increment of a change in the pan, the tilt, and the zoom of the video sensing device that is implemented by input via the pan icon, the tilt icon, and the zoom icon.

At 955, input is received from a user, and a location of interest is displayed in the thumbnail as a function of the user input. At 960, an icon is displayed in the thumbnail indicating the location of interest, input is received from a user via the location of interest icon, and the pan, tilt, and zoom of the video sensing device is altered as a function of the input received via the location of interest icon so that the location of interest is displayed in the thumbnail. At 965, input is received from a user to disable a display of the location of interest in the thumbnail. At 970, a plurality of locations of interest is automatically scanned in the thumbnail. At 975, the plurality of locations of interest is automatically scanned on a periodic basis. At 980, input is received from a user to add a new location of interest in the thumbnail while the plurality of locations of interest in the thumbnail is being scanned by the video sensing device.

At 985, the pan icon comprises a pan bar, the zoom icon comprises a zoom bar, and the tilt icon comprises a tilt bar. At 990, one or more of the pan bar, the tilt bar, and the zoom bar are configured such that a user can alter an increment of a change in the pan, the tilt, and the zoom of the video sensing device that is implemented by movement along the pan bar, the tilt bar, and the zoom bar.

At 995, an identifier of the video sensing device and the pan, tilt and zoom parameters of the video sensing device are displayed in the thumbnail. At 997, one or more of the pan icon, tilt icon, and zoom icon comprise a control for an extreme pan, an extreme tilt, and an extreme zoom.

### EXAMPLE EMBODIMENTS

Example No. 1 is a system including a video sensing device, a computer processor coupled to the video sensing device, and a display unit coupled to the computer processor. The system is configured to display a field of view of the video sensing device as a thumbnail on a main display of an area, receive input from a user, wherein the input received from the user is received via one or more of a pan icon, a zoom icon, and a tilt icon, automatically calculate a change in one or more of a pan, a tilt, and a zoom of the video sensing device as a function of the input, alter one or more of the pan, the tilt, and the zoom of the video sensing device as a function of the calculations, and display a new field of view of the video sensing device in the thumbnail as a function of the alteration of the pan, tilt, and zoom of the video sensing device.

Example No. 2 includes the features of Example No. 1 and optionally includes a system configured to modify an icon of the video sensing device and to modify an icon of a representation of the field of view of the video sensing device as a function of the user input via the pan icon, the zoom icon, and the tilt icon.

Example No. 3 includes the features of Example Nos. 1-2 and optionally includes a system wherein input via one or more of the pan icon, the tilt icon, and the zoom icon causes an actual image of the video sensing device in the thumbnail, an icon of the video sensing device, and an icon of a footprint of the video sensing device to change synchronously.

Example No. 4 includes the features of Example Nos. 1-3, and optionally includes a system wherein the pan icon comprises a circle or oval, thereby allowing a 360 degree pan of the video sensing device.

Example No. 5 includes the features of Example Nos. 1-4 and optionally includes a system configured to change a characteristic of the pan icon when a pan limit of the video sensing device is reached, change a characteristic of the tilt icon when a tilt limit of the video sensing device is reached, and change a characteristic of the zoom icon when a zoom limit of the video sensing device is reached.

Example No. 6 includes the features of Example Nos. 1-5 and optionally includes a system wherein one or more of the pan icon, the tilt icon, and the zoom icon are configured such that a user can alter an increment of a change in the pan, the tilt, and the zoom of the video sensing device that is implemented by input via the pan icon, the tilt icon, and the zoom icon.

Example No. 7 includes the features of Example Nos. 1-6 and optionally includes a system configured to receive input from a user, and display a location of interest in the thumbnail as a function of the user input.

Example No. 8 includes the features of Example Nos. 1-7 and optionally includes a system configured to display an icon in the thumbnail indicating the location of interest, to receive input from the user via the location of interest icon, and to alter the pan, tilt, and zoom of the video sensing device as a function of the input received via the location of interest icon so that the location of interest is displayed in the thumbnail.

Example No. 9 includes the features of Example Nos. 1-8 and optionally includes a system configured to receive input from the user to disable a display of the location of interest in the thumbnail.

Example No. 10 includes the features of Example Nos. 1-9 and optionally includes a system configured to automatically scan among a plurality of locations of interest in the thumbnail.

Example No. 11 includes the features of Example Nos. 1-10 and optionally includes a system configured to automatically scan the plurality of locations of interest on a periodic basis.

Example No. 12 includes the features of Example Nos. 1-11 and optionally includes a system configured to receive input from a user to add a new location of interest in the thumbnail while the plurality of locations of interest in the thumbnail is being scanned by the video sensing device.

Example No. 13 includes the features of Example Nos. 1-12 and optionally includes a system wherein the pan icon comprises a pan bar, the zoom icon comprises a zoom bar, and the tilt icon comprises a tilt bar.

Example No. 14 includes the features of Example Nos. 1-13 and optionally includes a system wherein one or more of the pan bar, the tilt bar, and the zoom bar are configured such that a user can alter an increment of a change in the pan, the tilt, and the zoom of the video sensing device that is implemented by movement along the pan bar, the tilt bar, and the zoom bar.

Example No. 15 includes the features of Example Nos. 1-14 and optionally includes a system configured to display in the thumbnail an identifier of the video sensing device and the pan, tilt and zoom parameters of the video sensing device.

Example No. 16 includes the features of Example Nos. 1-15 and optionally includes a system wherein one or more of the pan icon, tilt icon, and zoom icon comprise a control for an extreme pan, an extreme tilt, and an extreme zoom.

Example No. 17 is a computer-readable medium including instructions that when executed by a processor execute a process comprising displaying a field of view of a video sensing device as a thumbnail on a main display of an area, receiving input from a user, wherein the input received from the user is received via one or more of a pan icon, a zoom icon, and a tilt icon, automatically calculating a change in one or more of a pan, a tilt, and a zoom of the video sensing device as a function of the input, altering one or more of the pan, the tilt, and the zoom of the video sensing device as a function of the calculations, and displaying a new field of view of the video sensing device in the thumbnail as a function of the alteration of the pan, tilt, and zoom of the video sensing device.

Example No. 18 includes the features of Example No. 17, and optionally includes instructions such that input via one or more of the pan icon, the tilt icon, and the zoom icon causes an actual image of the video sensing device in the thumbnail, an icon of the video sensing device, and an icon of a footprint of the video sensing device to change synchronously.

Example No. 19 is a process including displaying a field of view of a video sensing device as a thumbnail on a main display of an area, receiving input from a user, wherein the input received from the user is received via one or more of a pan icon, a zoom icon, and a tilt icon, automatically calculating a change in one or more of a pan, a tilt, and a zoom of the video sensing device as a function of the input, altering one or more of the pan, the tilt, and the zoom of the video sensing device as a function of the calculations, and displaying a new field of view of the video sensing device in the thumbnail as a function of the alteration of the pan, tilt, and zoom of the video sensing device.

Example No. 20 includes the features of Example No. 19 and optionally includes a process wherein input via one or more of the pan icon, the tilt icon, and the zoom icon causes an actual image of the video sensing device in the thumbnail, an icon of the video sensing device, and an icon of a footprint of the video sensing device to change synchronously.

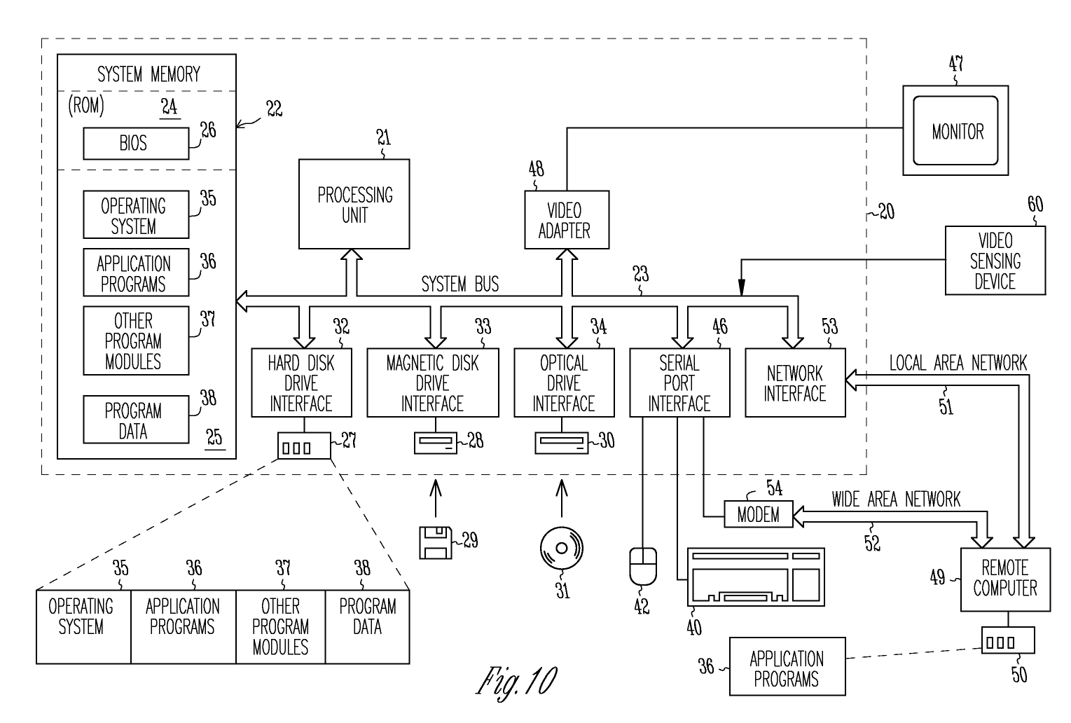

FIG. 10 is an overview diagram of a hardware and operating environment in conjunction with which embodiments of the invention may be practiced. The description of FIG. 10 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 10, a hardware and operating environment is provided that is applicable to any of the servers and/or remote clients shown in the other Figures.

As shown in FIG. 10, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 10 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Video sensing device 60 is coupled to the processing unit 21 via system bus 23, and is coupled to the monitor 47 via the system bus 23 and the video adapter 48.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a video sensing device;
a computer processor coupled to the video sensing device; and
a display unit coupled to the computer processor;
wherein the system is configured to:
display a field of view of the video sensing device as a thumbnail on a main display of an area;
receive input from a user, wherein the input received from the user is received via one or more of a pan icon, a zoom icon, and a tilt icon;
automatically calculate a change in one or more of a pan, a tilt, and a zoom of the video sensing device as a function of the input;
alter one or more of the pan, the tilt, and the zoom of the video sensing device as a function of the calculations; and
display a new field of view of the video sensing device in the thumbnail as a function of the alteration of the pan, tilt, and zoom of the video sensing device.

2. The system of claim 1, configured to modify an icon of the video sensing device and to modify an icon of a representation of the field of view of the video sensing device as a function of the user input via the pan icon, the zoom icon, and the tilt icon.

3. The system of claim 1, wherein input via one or more of the pan icon, the tilt icon, and the zoom icon causes an actual image of the video sensing device in the thumbnail, an icon of the video sensing device, and an icon of a footprint of the video sensing device to change synchronously.

4. The system of claim 1, wherein the pan icon comprises a circle or oval, thereby allowing a 360 degree pan of the video sensing device.

5. The system of claim 1, configured to change a characteristic of the pan icon when a pan limit of the video sensing device is reached, change a characteristic of the tilt icon when a tilt limit of the video sensing device is reached, and change a characteristic of the zoom icon when a zoom limit of the video sensing device is reached.

6. The system of claim 1, wherein one or more of the pan icon, the tilt icon, and the zoom icon are configured such that a user can alter an increment of a change in the pan, the tilt, and the zoom of the video sensing device that is implemented by input via the pan icon, the tilt icon, and the zoom icon.

7. The system of claim 1, configured to receive input from a user, and display a location of interest in the thumbnail as a function of the user input.

8. The system of claim 7, configured to display an icon in the thumbnail indicating the location of interest, to receive input from the user via the location of interest icon, and to alter the pan, tilt, and zoom of the video sensing device as a function of the input received via the location of interest icon so that the location of interest is displayed in the thumbnail.

9. The system of claim 7, configured to receive input from the user to disable a display of the location of interest in the thumbnail.

10. The system of claim 7, configured to automatically scan among a plurality of locations of interest in the thumbnail.

11. The system of claim 10, configured to automatically scan the plurality of locations of interest on a periodic basis.

12. The system of claim 10, configured to receive input from a user to add a new location of interest in the thumbnail while the plurality of locations of interest in the thumbnail is being scanned by the video sensing device.

13. The system of claim 1, wherein the pan icon comprises a pan bar, the zoom icon comprises a zoom bar, and the tilt icon comprises a tilt bar.

14. The system of claim 13, wherein one or more of the pan bar, the tilt bar, and the zoom bar are configured such that a user can alter an increment of a change in the pan, the tilt, and the zoom of the video sensing device that is implemented by movement along the pan bar, the tilt bar, and the zoom bar.

15. The system of claim 1, configured to display in the thumbnail an identifier of the video sensing device and the pan, tilt and zoom parameters of the video sensing device.

16. The system of claim 1, wherein one or more of the pan icon, tilt icon, and zoom icon comprise a control for an extreme pan, an extreme tilt, and an extreme zoom.

17. A computer-readable medium comprising instructions that when executed by a processor execute a process comprising:
displaying a field of view of a video sensing device as a thumbnail on a main display of an area;
receiving input from a user, wherein the input received from the user is received via one or more of a pan icon, a zoom icon, and a tilt icon;
automatically calculating a change in one or more of a pan, a tilt, and a zoom of the video sensing device as a function of the input;
altering one or more of the pan, the tilt, and the zoom of the video sensing device as a function of the calculations; and
displaying a new field of view of the video sensing device in the thumbnail as a function of the alteration of the pan, tilt, and zoom of the video sensing device.

18. The computer-readable medium of claim 17, wherein input via one or more of the pan icon, the tilt icon, and the zoom icon causes an actual image of the video sensing device in the thumbnail, an icon of the video sensing device, and an icon of a footprint of the video sensing device to change synchronously.

19. A process comprising:
displaying a field of view of a video sensing device as a thumbnail on a main display of an area;
receiving input from a user, wherein the input received from the user is received via one or more of a pan icon, a zoom icon, and a tilt icon;
automatically calculating a change in one or more of a pan, a tilt, and a zoom of the video sensing device as a function of the input;
altering one or more of the pan, the tilt, and the zoom of the video sensing device as a function of the calculations; and
displaying a new field of view of the video sensing device in the thumbnail as a function of the alteration of the pan, tilt, and zoom of the video sensing device.

20. The process of claim 19, wherein input via one or more of the pan icon, the tilt icon, and the zoom icon causes an actual image of the video sensing device in the thumbnail, an icon of the video sensing device, and an icon of a footprint of the video sensing device to change synchronously.
